(19) United States
(12) Patent Application Publication
(10) Pub. No.: US 2024/0152202 A1
(43) Pub. Date: May 9, 2024

(54) WEARABLE DEVICE FOR CONTROLLING MULTIMEDIA CONTENT PLACED IN VIRTUAL SPACE AND METHOD THEREOF

(71) Applicant: Samsung Electronics Co., Ltd., Suwon-si (KR)

(72) Inventors: Hanbeen KIM, Suwon-si (KR); Soonsang PARK, Suwon-si (KR); Jongwon LEE, Suwon-si (KR); Miyeoung CHUNG, Suwon-si (KR)

(21) Appl. No.: 18/362,152

(22) Filed: Jul. 31, 2023

Related U.S. Application Data
(63) Continuation of application No. PCT/KR2023/010334, filed on Jul. 18, 2023.

(30) Foreign Application Priority Data
Nov. 9, 2022 (KR) 10-2022-0149073
Nov. 14, 2022 (KR) 10-2022-0152098

(51) Int. Cl. G06F 3/01; G06F 3/16; G06T 19/00

(52) U.S. Cl. CPC G06F 3/011; G06F 3/167; G06T 19/00

(57) ABSTRACT

A wearable device according to an embodiment identifies a plurality of multimedia contents included in virtual space, based on identifying an input indicating entry into the virtual space. The wearable device obtains an order for outputting the plurality of multimedia contents, based on profile information of a user corresponding to the wearable device. The wearable device displays at least a portion of the virtual space including a visual object representing at least one multimedia content among the plurality of multimedia contents through a display, in the user's FoV, based on the order. The present disclosure is related to a metaverse service for enhancing interconnectivity between a real object and a virtual object. For example, the metaverse service is provided through a network based on fifth generation (5G) and/or sixth generation (6G).

### CROSS-REFERENCE TO RELATED APPLICATIONS

This application is a continuation of International Application No. PCT/KR2023/010334 designating the United States, filed on Jul. 18, 2023, in the Korean Intellectual Property Receiving Office and claiming priority to Korean Patent Application Nos. 10-2022-0149073, filed on Nov. 9, 2022, and 10-2022-0152098, filed on Nov. 14, 2022, in the Korean Intellectual Property Office, the disclosures of each of which are incorporated by referenced herein in their entireties.

### BACKGROUND

### Technical Field

The disclosure relates to a wearable device for controlling a visual object placed in virtual space and method thereof.

### Description of Related Art

In order to provide an enhanced user experience, an electronic device providing an augmented reality (AR) service displaying information generated by a computer in association with an external object in the real-world is being developed. The electronic device may be a wearable device that may be worn by a user. For example, the electronic device may be AR glasses and/or a head-mounted device (HMD). The electronic device may adjust the position and/or form of external objects provided in the augmented reality service using user information.

### SUMMARY

A wearable device according to an embodiment may comprise: a display and a processor. The processor may be configured to identify a plurality of multimedia contents included in the virtual space, based on identifying an input indicating entry into the virtual space. The processor may be configured to obtain an order for outputting the plurality of multimedia contents, based on profile information of a user corresponding to the wearable device. The processor may be configured to display at least a portion of the virtual space including a visual object representing at least one multimedia content among the plurality of multimedia contents through the display, in the user's field-of-view (FoV), based on the order.

A method of a wearable device according to an embodiment may comprise identifying properties about a plurality of multimedia contents based on identifying an input indicating entry into virtual space including the plurality of multimedia contents, from a user, while the wearable device is worn by the user. The method may comprise obtaining order for outputting the plurality of multimedia contents among the plurality of multimedia contents, based on profile information of the user related to the properties. The method may comprise selecting at least one multimedia content to be displayed to the user, among the plurality of multimedia contents, based on the order. The method may comprise displaying a screen representing at least a portion of the virtual space including a visual object representing the at least one multimedia content in a FoV of the wearable device, by controlling a display.

A wearable device according to an embodiment may comprise a display and a processor. The processor may be configured to identify properties about a plurality of multimedia contents based on identifying an input indicating entry into virtual space including the plurality of multimedia contents, from a user, while the wearable device is worn by the user. The processor may be configured to obtain an order for outputting the plurality of multimedia contents among the plurality of multimedia contents, based on profile information of the user related to the properties. The processor may be configured to select at least one multimedia content to be displayed to the user, among the plurality of multimedia contents, based on the order. The processor may be configured to display a screen representing at least a portion of the virtual space including a visual object representing the at least one multimedia content in a FoV of the wearable device by controlling the display.

A method of a wearable device according to an embodiment may comprise identifying a plurality of multimedia contents included in virtual space, based on identifying an input indicating entry into the virtual space. The method may comprise obtaining an order for outputting the plurality of multimedia contents, based on profile information of a user corresponding to the wearable device. The method may comprise displaying at least a portion of the virtual space including a visual object representing at least one of the plurality of multimedia contents through the display, in the user's FoV, based on the order.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is an exemplary diagram of a first embodiment environment in which a metaverse service is provided through a server.

FIG. 2 is an exemplary diagram of a second embodiment environment in which a metaverse service is provided through direct connection of user terminals.

FIG. 3A shows an example of a perspective view of a wearable device according to an embodiment.

FIG. 3B shows an example of one or more hardware placed in a wearable device according to an embodiment.

FIGS. 4A to 4B show an example of an appearance of a wearable device according to an embodiment.

FIG. 5 is an exemplary block diagram of a wearable device according to an embodiment.

FIG. 6 shows an exemplary state indicating a wearable device that has entered virtual space according to an embodiment.

FIGS. 7A to 7B show an exemplary state in which a wearable device according to an embodiment indicates obtaining a visual object corresponding to external objects included in virtual space.

FIG. 8 shows an exemplary state indicating an interaction between a wearable device and a user according to an embodiment.

FIG. 9 is an exemplary flowchart indicating an operation of a wearable device according to an embodiment.

FIG. 10 is an exemplary flowchart indicating an operation of a wearable device according to an embodiment.

FIG. 11 shows an exemplary state in which a wearable device according to an embodiment indicates obtaining a visual object based on a type of virtual space.

FIG. 12 is an exemplary flowchart indicating an operation of a wearable device according to an embodiment.

### DETAILED DESCRIPTION

Hereinafter, various example embodiments of the present disclosure will be described in greater detail with reference to the accompanying drawings.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Metaverse is a compound word of the English word “Meta”, which means “virtual” and “transcendence,” and “Universe”, which means the universe, and refers to a three-dimensional virtual world where social, economic, and cultural activities like the real-world take place. Metaverse is a concept that has evolved one step further than virtual reality (VR, a state-of-the-art technology that enables people to experience real-life experience in a virtual world created by a computer) and is characterized by using avatars to not only enjoy games or virtual reality, but also to engage in social and cultural activities like real reality.

Such a metaverse service may be provided in at least two forms. The first is to provide service to a user by using a server, and the second is to provide service through individual contact between users.

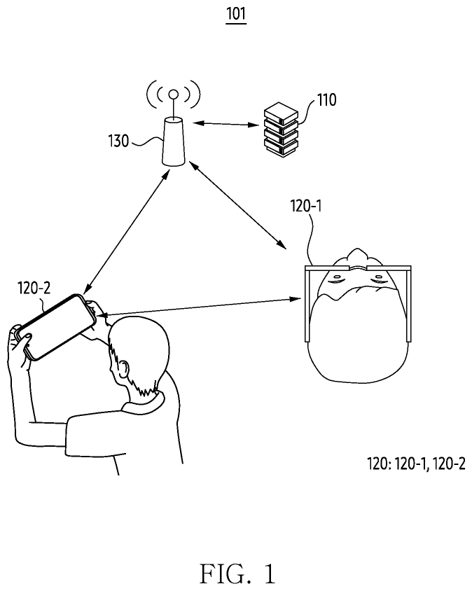

FIG. 1 is an exemplary view of a first embodiment environment 101 in which a metaverse service is provided through a server 110.

Referring to FIG. 1, the first embodiment environment 101 is configured with a server 110 providing a metaverse service, a network (e.g., a network formed by at least one intermediate node 130 including an access point (AP) and/or a base station) connecting the server 110 and each user terminal (e.g., a user terminal 120 including a first terminal 120-1 and a second terminal 120-2), and a user terminal that connects to the server through a network and allows a user to use the service by inputting and outputting to the metaverse service.

Hereat, the server 110 provides virtual space so that the user terminal 120 may perform activities in the virtual space. In addition, the user terminal 120 installs an S/W agent to access the virtual space provided by the server 110 to represent information provided by the server 110 to the user or to transmit information that the user wants to represent in the virtual space to the server.

The S/W agent may be provided directly through the server 110, downloaded from a public server, or embedded when purchasing a terminal.

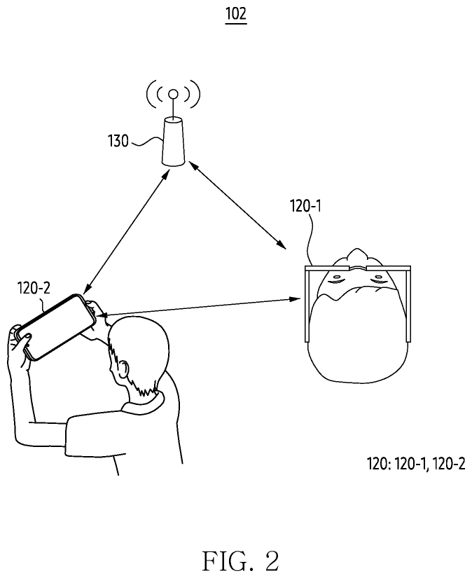

FIG. 2 is an exemplary view of a second embodiment environment 102 in which a metaverse service is provided through direct connection of user terminals (e.g., the first terminal 120-1 and the second terminal 120-2).

Referring to FIG. 2, the second embodiment environment 102 is configured with the first terminal 120-1 providing the metaverse service, a network (e.g., a network formed by at least one intermediate node 130) connecting each user terminal, and the second terminal 120-2 that connects to the first terminal 120-1 through a network and allows a second user to use the service by inputting and outputting to the metaverse service.

The second embodiment is characterized in that the first terminal 120-1 provides the metaverse service by performing the role of the server (e.g., the server 110 of FIG. 1) in the first embodiment. In other words, it may be seen that the metaverse environment may be configured only by connecting the device and the device.

In the first and second embodiments, the user terminal 120 (or the user terminal 120 including the first terminal 120-1 and the second terminal 120-2) may be made in various form factors and is characterized in that it includes an output device for providing video or/and sound to a user and an input device for inputting information to the metaverse service. Examples of various form factors of the user terminal 120 may include a smartphone (e.g., the second terminal 120-2), an AR device (e.g., the first terminal 120-1), a virtual reality (VR) device, a mixed reality (MR) device, a video see through (VST) device, and a TV or projector capable of input and output.

The network of the present disclosure (e.g., a network formed by at least one intermediate node 130) may include, for example, both various broadband networks including 3G, 4G, and 5G and local area network (e.g., a wired network or a wireless network directly connecting the first terminal 120-1 and the second terminal 120-2) including a wireless fidelity (WiFi) and bluetooth (BT).

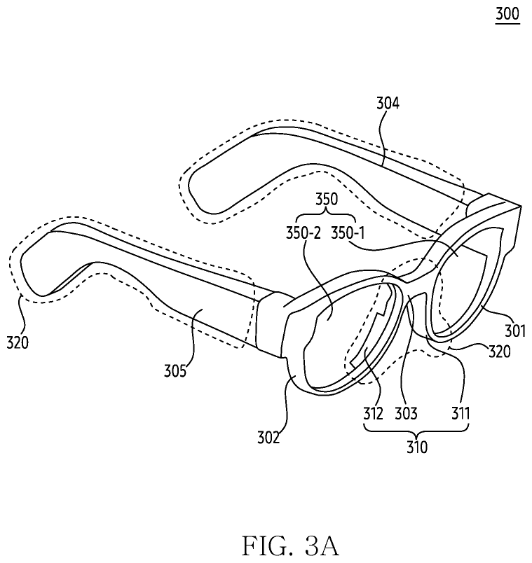

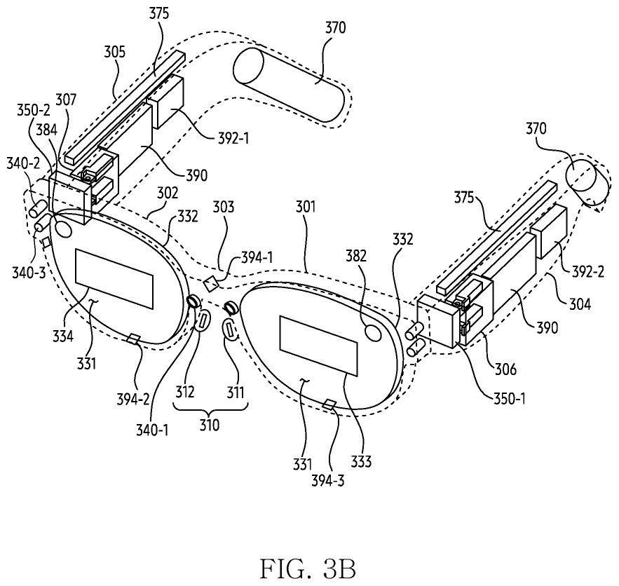

FIG. 3A shows an example of a perspective view of a wearable device 300 according to an embodiment. FIG. 3B shows an example of one or more hardware placed in the wearable device 300 according to an embodiment. The wearable device 300 of FIGS. 3A and 3B may include the first terminal 120-1 of FIGS. 1 and 2. As shown in FIG. 3A, according to an embodiment, the wearable device 300 may include at least one display 350 and a frame supporting the at least one display 350.

According to an embodiment, the wearable device 300 may be worn on a portion of a user's body. The wearable device 300 may provide augmented reality (AR), virtual reality (VR), or mixed reality (MR) combining augmented reality and virtual reality to a user wearing the wearable device 300. For example, the wearable device 300 may output a virtual reality video to the user through the at least one display 350 in response to a user's designated gesture obtained through a gesture recognition camera 340-2 of FIG. 3B.

According to an embodiment, the at least one display 350 in the wearable device 300 may provide visual information to a user. For example, the at least one display 350 may include a transparent or translucent lens. The at least one display 350 may include a first display 350-1 and/or a second display 350-2 spaced apart from the first display 350-1. For example, the first display 350-1 and the second display 350-2 may be placed at positions corresponding to the user's left and right eyes, respectively.

Referring to FIG. 3B, the at least one display 350 according to an embodiment may provide a user wearing the wearable device 300 with visual information included in external light passing through a lens and other visual information that is different from the visual information by forming a display area on the lens. The lens may be formed based on at least one of a fresnel lens, a pancake lens, or a multi-channel lens. The display area formed by the at least one display 350 may be formed on a second surface 332 of the first surface 331 and the second surface 332 of the lens. When a user wears the wearable device 300, external light may be transmitted to the user by being incident on the first surface 331 and passing through the second surface 332. For another example, the at least one display 350 may display a virtual reality video to be coupled to a reality screen transmitted through external light. The virtual reality video output from the at least one display 350 may be transmitted to the user's eyes through one or more hardware included in the wearable device 300 and/or at least one waveguides 333 and 334.

According to an embodiment, the wearable device 300 may include waveguides 333 and 334 that diffract light transmitted from the at least one display 350 and relayed by optical devices 382 and 384 and deliver it to a user. The waveguides 333 and 334 may be formed based on at least one of glass, plastic, or polymer. A nanopattern may be formed on at least a portion of the outside or inside of the waveguides 333 and 334. The nanopattern may be formed based on a grating structure having a polygonal and/or curved shape. Light incident to on one end of the waveguides 333 and 334 may be propagated to another end of the waveguides 333 and 334 by the nanopattern. The waveguides 333 and 334 may include at least one of at least one diffractive element (e.g., a diffractive optical element (DOE), a holographic optical element (HOE)), and a reflective element (e.g., a reflective mirror). For example, the waveguides 333 and 334 may be placed in the wearable device 300 to guide a screen displayed by the at least one display 350 to the user's eyes. For example, the screen may be transmitted to the user's eyes based on total internal reflection (TIR) generated in the waveguides 333 and 334.

According to an embodiment, the wearable device 300 may analyze an object included in a reality video collected through a photographing camera 340-3, may combine a virtual object corresponding to an object to be provided for augmented reality among the analyzed objects, and may display it in the at least one display 350. The virtual object may include at least one of text and images for various information related to an object included in the reality video. The wearable device 300 may analyze an object based on a multi-camera such as a stereo camera. For the object analysis, the wearable device 300 may execute time-of-flight (ToF) and/or simultaneous localization and mapping (SLAM) supported by the multi-camera. A user wearing the wearable device 300 may watch a video displayed on the at least one display 350.

According to an embodiment, a frame may have a physical structure in which the wearable device 300 may be worn on a user's body. According to an embodiment, the frame may be configured so that when the user wears the wearable device 300, the first display 350-1 and the second display 350-2 may be positioned corresponding to the user's left and right eyes. The frame may support the at least one display 350. For example, the frame may support the first display 350-1 and the second display 350-2 to be positioned at positions corresponding to the user's left and right eyes.

Referring to FIG. 3A, a frame according to an embodiment may include an area 320 in which at least a portion of the frame contacts a portion of a user's body in case that the user wears the wearable device 300. For example, the area 320 of the frame in contact with a portion of the user's body may include an area in contact with a portion of the user's nose, a portion of the user's ear, and a portion of the side of the user's face that the wearable device 300 contacts. According to an embodiment, the frame may include a nose pad 310 in contact with a portion of the user's body. When the wearable device 300 is worn by a user, the nose pad 310 may contact a portion of the user's nose. The frame may include a first temple 304 and a second temple 305 in contact with other portion of the user's body, which is distinct from the portion of the user's body.

For example, the frame may include a first rim 301 surrounding at least a portion of the first display 350-1, a second rim 302 surrounding at least a portion of the second display 350-2, a bridge 303 placed between the first rim 301 and the second rim 302, a first pad 311 placed along a portion of the edge of the first rim 301 from one end of the bridge 303, a second pad 312 placed along a portion of the edge of the second rim 302 from another end of the bridge 303, a first temple 304 extending from the first rim 301 and fixed to a portion of the wearer's ear, and a second temple 305 extending from the second rim 302 and fixed to a portion of the ear opposite the ear. The first pad 311 and the second pad 312 may be in contact with a portion of the user's nose, and the first temple 304 and the second temple 305 may be in contact with a portion of the user's face and a portion of the ear. The temples 304 and 305 may be rotatably connected to the rim through hinge units 306 and 307 of FIG. 3B. The first temple 304 may be rotatably connected to the first rim 301 through the first hinge unit 306 placed between the first rim 301 and the first temple 304. The second temple 305 may be rotatably connected to the second rim 302 through the second hinge unit 307 placed between the second rim 302 and the second temple 305. According to an embodiment, the wearable device 300 may identify an external object (e.g., a user's fingertip) touching the frame and/or a gesture performed by the external object using a touch sensor, a grip sensor, and/or a proximity sensor formed on at least a portion of the surface of the frame.

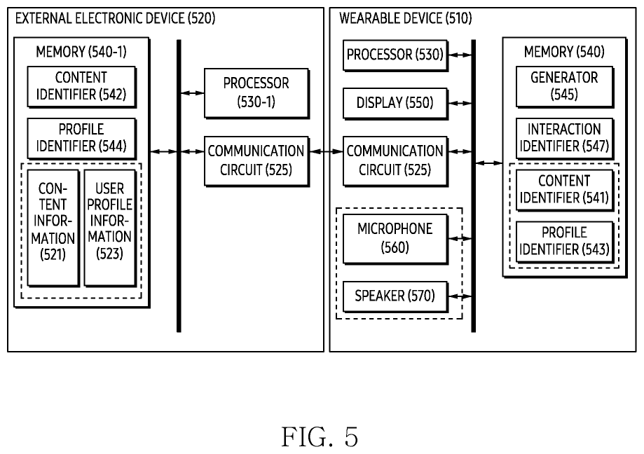

According to an embodiment, the wearable device 300 may include hardware that performs various functions (e.g., hardware described above based on the block diagram of FIG. 5). For example, the hardware may include a battery module 370, an antenna module 375, optical devices 382 and 384, speakers 392-1 and 392-2, microphones 394-1, 394-2, and 394-3, a light emitting module (not shown), and/or a printed circuit board 390. Various hardware may be placed in the frame.

According to an embodiment, the microphones 394-1, 394-2, and 394-3 of the wearable device 300 may be placed on at least a portion of the frame to obtain a sound signal. Although a first microphone 394-1 placed on the nose pad 310, a second microphone 394-2 placed on the second rim 302, and a third microphone 394-3 placed on the first rim 301 are shown in FIG. 3B, the number and arrangement of the microphones 394 are not limited to an embodiment of FIG. 3B. In case that the number of microphones 394 included in the wearable device 300 is two or more, the wearable device 300 may identify the direction of the sound signal using a plurality of microphones placed on different portions of the frame.

According to an embodiment, the optical devices 382 and 384 may transmit a virtual object transmitted from the at least one display 350 to waveguides 333 and 334. For example, the optical devices 382 and 384 may be projectors. The optical devices 382 and 384 may be placed adjacent to the at least one display 350 or may be included in the at least one display 350 as a portion of the at least one display 350. The first optical device 382 may correspond to the first display 350-1, and the second optical device 384 may correspond to the second display 350-2. The first optical device 382 may transmit light output from the first display 350-1 to the first waveguide 333, and the second optical device 384 may transmit light output from the second display 350-2 to the second waveguide 334.

In an embodiment, a camera 340 may include an eye tracking camera (ET CAM) 340-1, a gesture recognition camera 340-2, and/or a photographing camera 340-3. The photographing camera, eye tracking camera 340-1, and gesture recognition camera 340-2 may be placed in different positions on the frame and may perform different functions. The eye tracking camera 340-1 may output data indicating gaze of a user wearing the wearable device 300. For example, the wearable device 300 may detect the gaze from an image including the user's pupils obtained through the eye tracking camera 340-1. An example in which the eye tracking camera 340-1 is placed facing toward the user's right eye is shown in FIG. 3B, but the embodiment is not limited thereto, and the eye tracking camera 340-1 may be placed singly facing toward the user's left eye or may be placed facing toward both eyes.

In an embodiment, the photographing camera 340-3 may photograph a real image or background to be matched with a virtual image to implement augmented reality or mixed reality content. The photographing camera may photograph an image of a specific object existing at a position viewed by the user and may provide the image to the at least one display 350. The at least one display 350 may display a video in which a real image or background information including the image of the specific object obtained using the photographing camera and a virtual image provided through the optical devices 382 and 384 are overlapped. In an embodiment, the photographing camera may be placed on the bridge 303 placed between the first rim 301 and the second rim 302.

The eye tracking camera 340-1 according to an embodiment may implement more realistic augmented reality by matching the user's gaze with visual information provided to the at least one display 350 by tracking the user's gaze wearing the wearable device 300. For example, when the user looks at the front, the wearable device 300 may naturally display environment information related to the user's front of the place where the user is located on at least one display 350. The eye tracking camera 340-1 may be configured to capture an image of the user's pupil to determine the user's gaze. For example, the eye tracking camera 340-1 may receive gaze detection light reflected from the user's pupil and may track the user's gaze based on the position and movement of the received gaze detection light. In an embodiment, the eye tracking camera 340-1 may be placed at a position corresponding to the user's left and right eyes. For example, the eye tracking camera 340-1 may be placed in the first rim 301 and/or the second rim 302 to face toward a direction in which the user wearing the wearable device 300 is located.

The gesture recognition camera 340-2 according to an embodiment may provide a specific event to a screen provided to the at least one display 350 by recognizing a movement of the entire or portion of the user's body, such as the user's torso, hand, or face. The gesture recognition camera 340-2 may obtain a signal corresponding to a gesture by recognizing the gesture of the user and may provide a display corresponding to the signal to the at least one display 350. A processor may identify a signal corresponding to the gesture and may perform a designated function based on the identification. In an embodiment, the gesture recognition camera 340-2 may be placed on the first rim 301 and/or the second rim 302.

The camera 340 included in the wearable device 300 according to an embodiment is not limited to the eye tracking camera 340-1 and gesture recognition camera 340-2 described above. For example, the wearable device 300 may identify an external object included in FoV using the photographing camera 340-3 placed facing toward the user's FoV. The identification of the external object by the wearable device 300 may be performed based on a sensor for identifying a distance between the wearable device 300 and the external object, such as a depth sensor and/or a time of flight (ToF) sensor. The camera 340 placed facing toward the FoV may support an autofocus function and/or an optical image stabilization (OIS) function. For example, the wearable device 300 may include the camera 340 (e.g., a face tracking (FT) camera) placed facing toward the face to obtain an image including the face of the user wearing a wearable device 300.

Although not shown, according to an embodiment, the wearable device 300 may further include a light source (e.g., LED) emitting light toward a subject (e.g., a user's eye, face, and/or an external object in the FoV) being photographed using the camera 340. The light source may include an LED of an infrared wavelength. The light source may be placed on at least one of the frame and hinge units 306 and 307.

According to an embodiment, the battery module 370 may supply power to electronic components of the wearable device 300. In an embodiment, the battery module 370 may be placed in the first temple 304 and/or the second temple 305. For example, the battery module 370 may be a plurality of battery modules 370. The plurality of battery modules 370 may be placed on the first temple 304 and the second temple 305, respectively. In an embodiment, the battery module 370 may be placed at an end of the first temple 304 and/or the second temple 305.

The antenna module 375 according to an embodiment may transmit a signal or power to the outside of the wearable device 300 or receive a signal or power from the outside. The antenna module 375 may be electrically and/or operatively connected to a communication circuit 525 of FIG. 5. In an embodiment, the antenna module 375 may be placed in the first temple 304 and/or the second temple 305. For example, the antenna module 375 may be placed close to one surface of the first temple 304 and/or the second temple 305.

The speakers 392-1 and 392-2 according to an embodiment may output a sound signal to the outside of the wearable device 300. A sound output module may be referred to as a speaker. In an embodiment, the speakers 392-1 and 392-2 may be placed in the first temple 304 and/or the second temple 305 to be placed adjacent to an ear of the user wearing the wearable device 300. For example, the wearable device 300 may include the second speaker 392-2 placed adjacent to the user's left ear by being placed in the first temple 304, and the first speaker 392-1 placed adjacent to the user's right ear by being placed in the second temple 305.

The light emitting module (not shown) according to an embodiment may include at least one light emitting element. The light emitting module may emit light of a color corresponding to a specific state or may emit light in an operation corresponding to the specific state to visually provide information on the specific state of the wearable device 300 to a user. For example, the wearable device 300 may repeatedly emit red light at a designated moment in case that charging is required. In an embodiment, the light emitting module may be placed on the first rim 301 and/or the second rim 302.

Referring to FIG. 3B, according to an embodiment, the wearable device 300 may include a printed circuit board (PCB) 390. The PCB 390 may be included in at least one of the first temple 304 or the second temple 305. The PCB 390 may include an interposer placed between at least two sub-PCBs. On the PCB 390, one or more hardware included in the wearable device 300 may be placed. The wearable device 300 may include a flexible PCB (FPCB) for interconnecting the hardware.

According to an embodiment, the wearable device 300 may include at least one of a gyro sensor, a gravity sensor, and/or an acceleration sensor for detecting the posture of the wearable device 300 and/or the posture of a body part (e.g., a head) of a user wearing the wearable device 300. The gravity sensor and the acceleration sensor may measure gravity acceleration and/or acceleration based on designated three-dimensional axes (e.g., x-axis, y-axis, and z-axis) perpendicular to each other, respectively. The gyro sensor may measure angular velocity of the designated three-dimensional axes (e.g., the x-axis, the y-axis, and the z-axis), respectively. The at least one of the gravity sensor, the acceleration sensor, and the gyro sensor may be referred to as an inertial measurement unit (IMU). According to an embodiment, the wearable device 300 may identify a user's motion and/or gesture performed to execute or stop a specific function of the wearable device 300 based on the IMU.

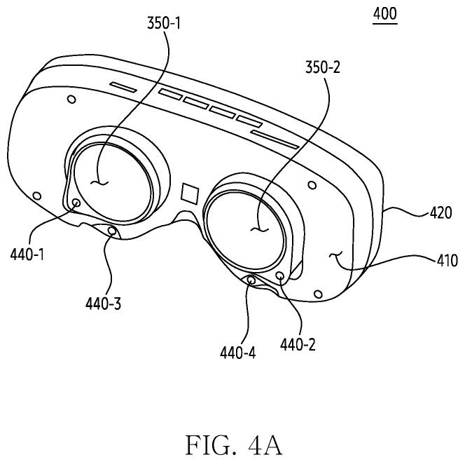

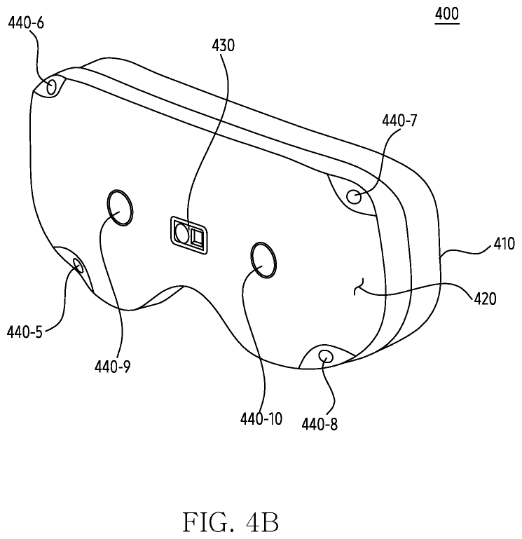

FIGS. 4A to 4B show an example of an appearance of a wearable device 400 according to an embodiment. The wearable device 400 of FIGS. 4A to 4B may include the first terminal 120-1 of FIGS. 1 to 2. According to an embodiment, an example of the appearance of a first surface 410 of a housing of the wearable device 400 may be shown in FIG. 4A, and an example of the appearance of a second surface 420 opposite to the first surface 410 may be shown in FIG. 4B.

Referring to FIG. 4A, according to an embodiment, the first surface 410 of the wearable device 400 may have a form that is attachable on a user's body part (e.g., the user's face). Although not shown, the wearable device 400 may further include a strap and/or one or more temples (e.g., the first temple 304 and/or the second temple 305 of FIGS. 3A to 3B) for being fixed on the user's body part. A first display 350-1 for outputting an image to the left eye among the user's both eyes and a second display 350-2 for outputting an image to the right eye among two eyes may be placed on the first surface 410. The wearable device 400 may further include a rubber or silicone packing for preventing and/or reducing interference by light (e.g., ambient light) different from light formed on the first surface 410 and emitted from the first display 350-1 and the second display 350-2.

According to an embodiment, the wearable device 400 may include cameras 440-1 and 440-2 for photographing and/or tracking a user's both eyes adjacent to the first display 350-1 and the second display 350-2, respectively. The cameras 440-1 and 440-2 may be referred to as an ET camera. According to an embodiment, the wearable device 400 may include cameras 440-3 and 440-4 for photographing and/or recognizing a user's face. The cameras 440-3 and 440-4 may be referred to as an FT camera.

Referring to FIG. 4B, a camera (e.g., cameras 440-5, 440-6, 440-7, 440-8, 440-9, and 440-10) and/or a sensor (e.g., a depth sensor 430) for obtaining information related to the external environment of the wearable device 400 may be placed on the second surface 420 opposite to the first surface 410 of FIG. 4A. For example, the cameras 440-5, 440-6, 440-7, 440-8, 440-9, and 440-10 may be placed on the second surface 420 to recognize an external object different from the wearable device 400. For example, using the cameras 440-9 and 440-10, the wearable device 400 may obtain an image and/or video to be transmitted to a user's both eyes, respectively. The camera 440-9 may be placed on the second surface 420 of the wearable device 400 to obtain an image to be displayed through the second display 350-2 corresponding to the right eye among two eyes. The camera 440-10 may be placed on the second surface 420 of the wearable device 400 to obtain an image to be displayed through the first display 350-1 corresponding to the left eye among two eyes.

According to an embodiment, the wearable device 400 may include the depth sensor 430 placed on the second surface 420 to identify a distance between the wearable device 400 and an external object. Using the depth sensor 430, the wearable device 400 may obtain spatial information (e.g., a depth map) on at least a portion of the FoV of a user wearing the wearable device 400.

Although not shown, a microphone for obtaining sound output from an external object may be placed on the second surface 420 of the wearable device 400. The number of microphones may be one or more according to embodiments.

Hereinafter, referring to FIG. 5, an example of one or more hardware included in a wearable device (e.g., the first terminal 120-1 of FIG. 1 to 2) including the wearable device 300 of FIGS. 3A and 3B and/or the wearable device 400 of FIGS. 4A and 4B, and an application executed by a wearable device 510 will be described.

FIG. 5 is an exemplary block diagram of a wearable device according to an embodiment. The wearable device 510 of FIG. 5 may include the first terminal 120-1 of FIGS. 1 and 2, the wearable device 300 of FIGS. 3A and 3B, and/or the wearable device 400 of FIGS. 4A and 4B. For example, the wearable device 510 may include a head-mounted display (HMD) that is wearable on a user's head.

Referring to FIG. 5, the wearable device 510 and an external electronic device 520 may be connected to each other based on a wired network and/or a wireless network. The wired network may include a network such as the Internet, a local area network (LAN), a wide area network (WAN), an Ethernet, or a combination thereof. The wireless network may include a network such as long term evolution (LTE), 5g new radio (NR), wireless fidelity (Wi-Fi), Zigbee, near field communication (NFC), Bluetooth, Bluetooth low-energy (BLE), or a combination thereof. Although the wearable device 510 and the external electronic device 520 are shown as being directly connected, the wearable device 510 and the external electronic device 520 may be indirectly connected through an intermediate node (e.g., one or more routers and/or access point (AP)) in the network.

The wearable device 510 according to an embodiment may include at least one of a processor (e.g., including processing circuitry) 530, a memory 540, a display 550, a communication circuit 525, a microphone 560, and a speaker 570. The processor 530, the memory 540, the display 550, the communication circuit 525, the microphone 560, and the speaker 570 may be electronically and/or operably coupled with each other by an electronical component such as a communication bus. Hereinafter, the operational coupling of hardware may refer, for example, to a direct or indirect connection between hardware being established by wire or wirelessly, so that a second hardware is controlled by a first hardware among the hardware. Hereinafter, when the hardware is operably coupled, it may refer, for example, to a direct connection or an indirect connection between the hardware being established by wire or wirelessly so that a second hardware is controlled by a first hardware among the hardware. Although shown based on different blocks, the embodiment is not limited thereto, and a portion of the hardware of FIG. 5 (e.g., at least a portion of the processor 530, the memory 540, and the communication circuit 525) may be included in a single integrated circuit such as a system on a chip (SoC). The type and/or number of hardware included in the wearable device 510 is not limited to that shown in FIG. 5. For example, the wearable device 510 may include only a portion of hardware components shown in FIG. 5.

The processor 530 of the wearable device 510 according to an embodiment may include various processing circuitry and hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). The processor 530 may have a structure of a single-core processor, or a structure of a multi-core processor such as a dual core, a quad core, or a hexa core.

The memory 540 of the wearable device 510 according to an embodiment may include a hardware component for storing data and/or instruction input and/or output to the processor 530 of the wearable device 510. The memory 540 may include, for example, volatile memory such as random-access memory (RAM) and/or non-volatile memory such as read-only memory (ROM). The volatile memory may include, for example, at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, hard disk, compact disk, solid state drive (SSD), and embedded multimedia card (eMMC).

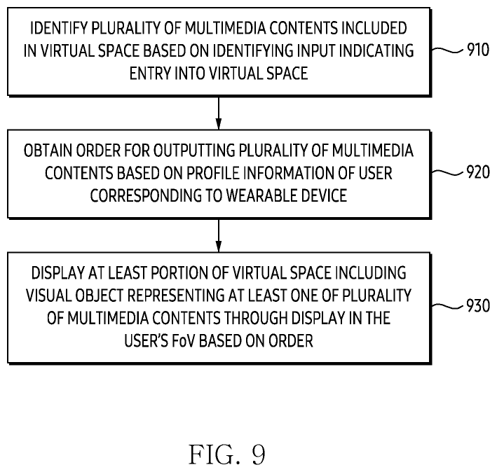

For example, in the memory 540 of the wearable device 510, one or more instructions (or commands) indicating an operation and/or calculation to be performed on data by the processor 530 of the wearable device 510 may be stored. A set of one or more instructions may be referred to as firmware, operating system, process, routine, sub-routine, and/or application. In a memory 540-1 of an external electronic device 520, one or more instructions indicating an operation and/or calculation to be performed on data by a processor 530-1 of the external electronic device 520 may be stored. Referring to FIG. 5, the processor 530 of the wearable device 510 may perform at least one of the operations of FIG. 9, 10, or 12 by executing one or more applications in the memory 540. Hereinafter, that an application is installed in an electronic device (e.g., the wearable device 510, and/or the external electronic device 520) may refer, for example, to one or more instructions provided in a form of an application being stored in the memory of the electronic device, and that the one or more applications are stored in a format (e.g., a file having an extension designated by an operating system of the electronic device) executable by a processor of the electronic device.

Referring to FIG. 5, one or more instructions included in at least one application stored in the memory 540 may be divided into a content identifier 541, a profile identifier 543, a generator 545, and/or an interaction identifier 547. For example, a state in which at least one application is executed may be referred to as a state identifying an input indicating entry into the virtual space of a processor 530. At least one application may be an example of an application for providing a metaverse service. The virtual space may refer, for example, to a space for displaying multimedia contents, such as an exhibition, a museum, or an art gallery. However, it is not limited to the embodiment described above.

For example, in response to receiving content information 521 from the external electronic device 520, the content identifier 541 may be used to identify a property, data capacity, and content constructor (e.g., a user who constructed the content) of each of the plurality of contents included in the virtual space. In a state in which the content identifier 541 is executed, the wearable device 510 may obtain the property of content based on embedding unstructured information (e.g., image, audio, and/or video information) included in the content. The property of content may refer, for example, to information for classifying the contents. For example, the property of content may be classified according to the genre of the content, such as painting, pop art, impressionism, or media art. However, the embodiment is not limited thereto. For example, in a case of music-related content, the property of content may be classified according to the genre such as jazz, pop music, rock, hip-hop, dance, ballad, or classical music. For example, the wearable device 510 may identify order of each content based on identifying the property of each of the contents. For example, the wearable device 510 may identify contents based on similar properties. The wearable device 510 may group contents based on the identified similar properties. The wearable device 510 may generate a visual object corresponding to the contents grouped above.

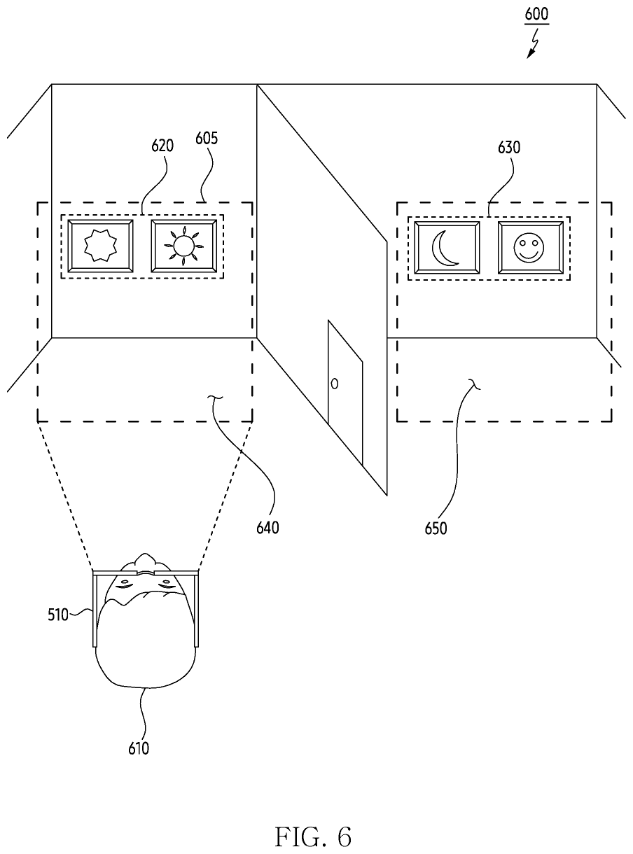

For example, the profile identifier 543 may be used to identify user preference indicating priority for each of the content properties by receiving user profile information 523 of the external electronic device 520 through the communication circuit 525 or using user profile information (not shown) stored in the memory 540. For example, the wearable device 510 may obtain order of contents included in the virtual space based on the user preference in a state in which the profile identifier 543 is executed. The wearable device 510 may output contents in a user's FoV based on the order. An operation in which the wearable device 510 outputs contents based on the order will be described in greater detail below with reference to FIG. 6.

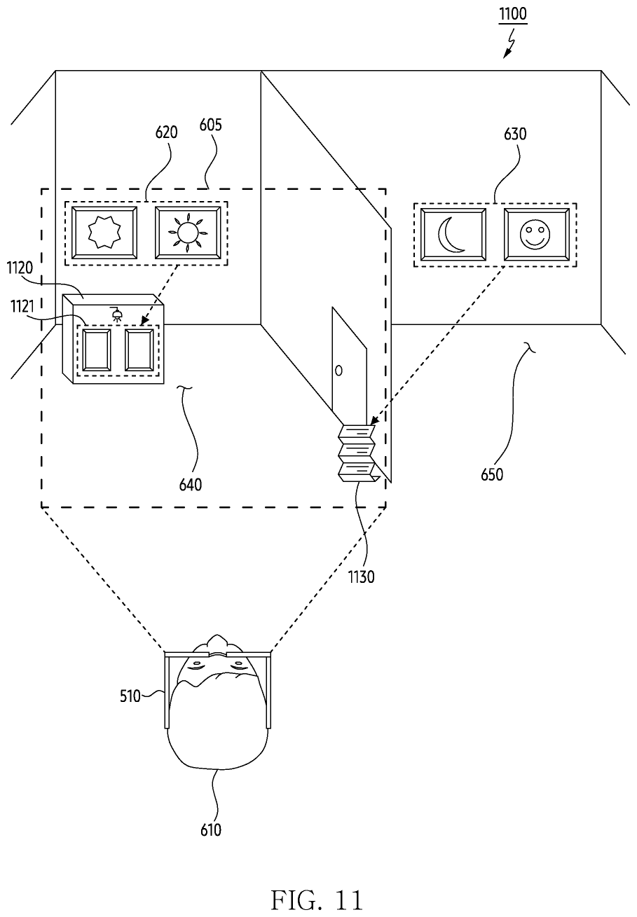

For example, the generator 545 may be used to generate a visual object corresponding to each of the contents included in the virtual space. In a state in which the generator 545 is executed, the wearable device 510 may generate a visual object corresponding to the content using the property obtained using the content identifier 541 and/or profile identifier 543 and a priority for each of the properties. Based on the priority, the wearable device 510 may identify a position where a visual object is to be placed in a user's FoV. For example, the wearable device 510 may generate a visual object based on a type of virtual space using the generator 545. An operation in which the wearable device 510 generates a visual object based on the type of virtual space will be described later in FIG. 11.

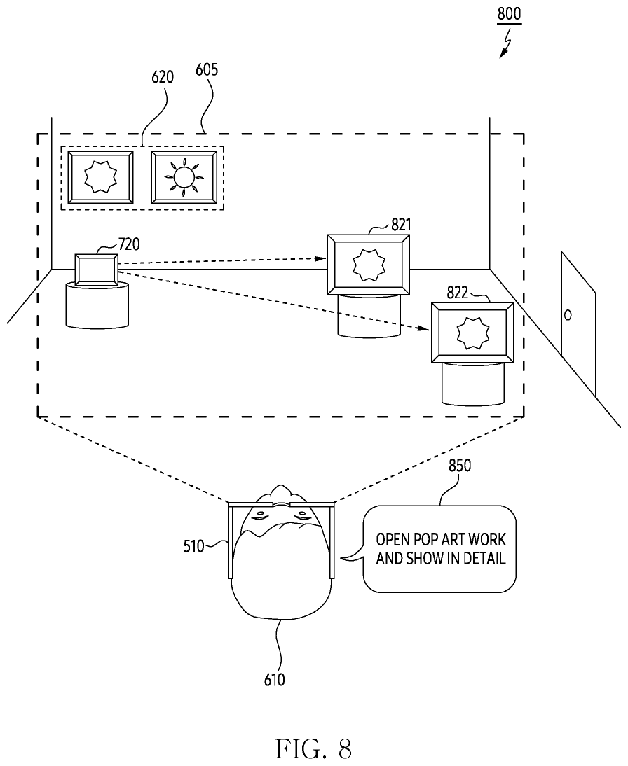

For example, the interaction identifier 547 may be used to control the position, size, and/or whether to display of content (or visual object) placed in the FoV based on identifying interaction with the user of the wearable device 510. In a state in which the interaction identifier 547 is executed, the wearable device 510 may control at least a portion of the contents by identifying a user's speech act using the microphone 560. An operation in which the wearable device 510 identifies an interaction with a user will be described later in FIG. 8.

For example, the wearable device 510 may store at least one information of position, property, and/or size information of content displayed in the FoV in a memory. The wearable device 510 may update the stored at least one information based on identifying an interaction with a user. The wearable device 510 may change at least a portion of the stored at least one information by updating. As an example, the position of the content may be changed.

The display 550 of the wearable device 510 according to an embodiment may output visualized information to a user. For example, the display 550 may output visualized information to a user by being controlled by the processor 530 including a circuit such as a graphical processing unit (GPU). The display 550 may include a flat panel display (FPD) and/or an electronic paper. The FPD may include a liquid crystal display (LCD), a plasma display panel (PDP), and/or one or more light emitting diode (LED). The LED may include an organic LED (OLED). The display 550 of FIG. 5 may include at least one display 350 of FIGS. 3A to 3B and/or 4A to 4B.

The communication circuit 525 of the wearable device 510 according to an embodiment may include hardware component for supporting transmission and/or reception of an electrical signal between the wearable device 510 and the external electronic device 520. Although only the external electronic device 520 is shown as an electronic device connected to the wearable device 510 through the communication circuit 525, the embodiment is not limited thereto. The communication circuit 525 may include, for example, at least one of a MODEM, an antenna, and an optic/electronic (O/E) converter. The communication circuit 525 may support transmission and/or reception of an electrical signal based on various types of protocols such as Ethernet, local area network (LAN), wide area network (WAN), wireless fidelity (Wi-Fi), Bluetooth, Bluetooth low energy (BLE), ZigBee, long term evolution (LTE), and 5G new radio (NR).

The microphone 560 of the wearable device 510 according to an embodiment may receive a sound signal (e.g., a user's voice). For example, the wearable device 510 may include one or more microphones. The wearable device 510 may place the microphone 560 on a portion of a housing of the wearable device 510. The microphone 560 may be referred to as a feedback microphone in terms of being placed adjacent to the speaker 570. The microphone 560 may be placed in a portion of a housing including a sensor (not shown) of the wearable device 510. The microphone 560 may be referred to as a feed-forward microphone in terms of being placed facing toward the outside of the wearable device 510. However, it is not limited thereto. An operation in which the wearable device 510 identifies an interaction with a user using the microphone 560 will be described later in FIG. 8.

The speaker 570 according to an embodiment may output an audio signal. For example, the wearable device 510 may receive audio data from an external device (e.g., the external electronic device 520, a server, a smartphone, a PC, a PDA, or an access point). The wearable device 510 may output the received audio data using the speaker 570. For example, the speaker 570 may receive an electrical signal. The speaker 570 may convert an electrical signal into a sound wave signal. The speaker 570 may output an audio signal including a converted sound wave signal.

Referring to FIG. 5, the external electronic device 520 may include at least one of a processor (e.g., including processing circuitry) 530-1, a memory 540-1, and a communication circuit 525. For example, the external electronic device 520 may be referred to a server (e.g., the server 110 of FIG. 1) for providing a metaverse service. For example, content information 521 and user profile information 523 may be stored in the memory 540-1 of the external electronic device 520 and may be used by the processor 530-1 of the external electronic device 520. Hereinafter, to reduce repetition, descriptions of the processor 530-1, the memory 540-1, and the communication circuit 525 in the external electronic device 520 may not be repeated in a range overlapping with the processor 530, the memory 540, and the communication circuit 525 of the wearable device 510. For example, a content identifier 542 and a profile identifier 544 of the external electronic device 520 may be referred to as the content identifier 541 and profile identifier 543 of the wearable device 510, respectively.

Referring to FIG. 5, one or more instructions included in at least one application stored in the memory 540-1 may be classified into the content identifier 542 and the profile identifier 544. For example, a state in which at least one application is executed may be referred to a state in which the processor 530-1 receives a signal indicating an input indicating entry into virtual space from the wearable device 510. However, it is not limited to the embodiment described above.

Content information 521 according to an embodiment may refer to information on a plurality of multimedia contents included in the virtual space. The plurality of multimedia contents may be an example of contents accessible to a user wearing the wearable device 510 in the virtual space. The content information 521 may be classified into structured information indicating properties or unstructured information configured of image information, audio information, and/or text information. The external electronic device 520 may transmit the content information 521 to the wearable device 510 that has entered the virtual space, using the communication circuit 525.

User profile information 523 according to an embodiment may include profile information of a user of the wearable device 510 that has entered the virtual space. For example, the user profile information may include at least one of the user's identification information (e.g., name, age, or gender), or information indicating the number of times each of a plurality of multimedia contents has been browsed. For example, the processor 530 of the wearable device 510 may obtain the priority of multimedia contents (or properties about multimedia contents) using the user profile information 523. For example, a user may set a priority corresponding to each of the multimedia contents (or properties about multimedia contents) based on the user's preference. The external electronic device 520 may store information indicating the set priority as the user profile information 523. In a state in which the wearable device 510 that has entered the virtual space is identified, the external electronic device 520 may transmit the user profile information 523 to the wearable device 510 using the communication circuit 525.

Within a state in which the wearable device 510 that has entered the virtual space is identified, the processor 530-1 of the external electronic device 520 according to an embodiment may identify multimedia contents included in the virtual space based on the execution of the content identifier 542 using the content information 521. For example, the processor 530-1 of the external electronic device 520 may identify a priority corresponding to each of the multimedia contents based on the user's preference, based on the execution of the profile identifier 544 using the user profile information 523. The external electronic device 520 may transmit first information indicating the identified multimedia contents to the wearable device 510. The processor 530-1 of the external electronic device 520 may transmit second information indicating the identified priority to the wearable device 510. The wearable device 510 may generate a visual object corresponding to each of the multimedia contents using the generator 545, based on receiving the first information and/or the second information from the external electronic device 520. However, it is not limited thereto.

As described above, the wearable device 510 according to an embodiment may identify multimedia contents included in the virtual space using the content information 521 received from the external electronic device 520 by entering the virtual space. The wearable device 510 may obtain order of multimedia contents based on a user's preference using the user profile information 523. The wearable device 510 may display a visual object representing at least one multimedia content among the multimedia contents in a user's FoV based on the obtained order. The wearable device 510 may efficiently control data for processing at least a portion of the virtual space by displaying at least one multimedia content (or visual object) selected based on the order in the FoV.

FIG. 6 shows an exemplary state indicating a wearable device that has entered virtual space according to an embodiment. According to an embodiment, the wearable device 510 may include a camera (e.g., the photographing camera 340-3 of FIG. 3B, and/or cameras 440-9 and 440-10 of FIG. 4B) placed facing toward a user's front in a state worn by the user. The user's front may include a direction in which a head of the user 610 and/or two eyes included in the head face toward. The wearable device 510 may control the camera to provide a UI based on AR, VR, and/or MR to the user 610 wearing the wearable device 510. The UI may be related to a metaverse service provided by the wearable device 510 and/or an external electronic device (e.g., the external electronic device 520 of FIG. 5) connected to the wearable device 510. Referring to FIG. 6, a state 600 indicating virtual space provided by a metaverse service will be shown.

Referring to FIG. 6, the wearable device 510 according to an embodiment may identify an input indicating entry into virtual space. Based on the identification of the input, the wearable device 510 may receive content information (e.g., the content information 521 of FIG. 5) and/or user profile information (e.g., the user profile information 523 of FIG. 5) from an external electronic device (e.g., the external electronic device 520 of FIG. 5) providing the virtual space using a communication circuit (e.g., the communication circuit 525 of FIG. 5).

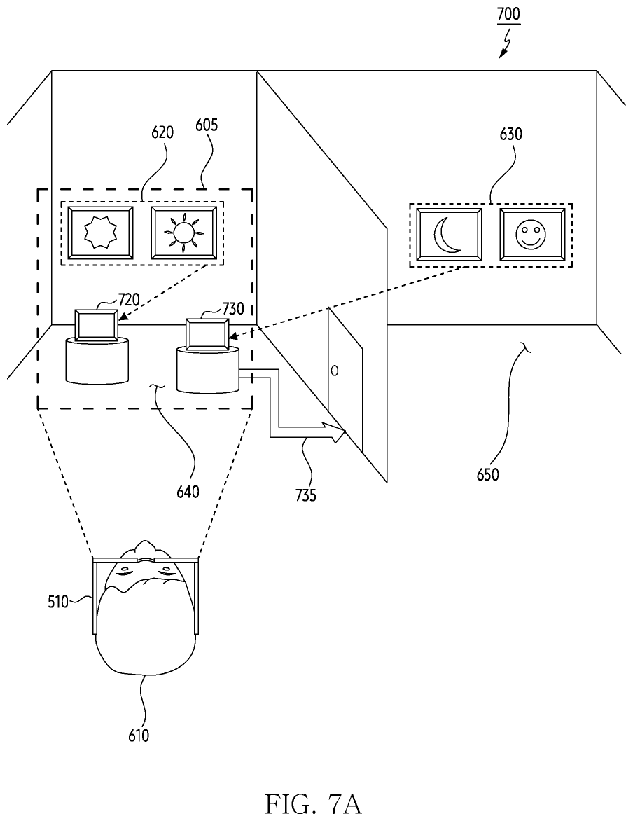

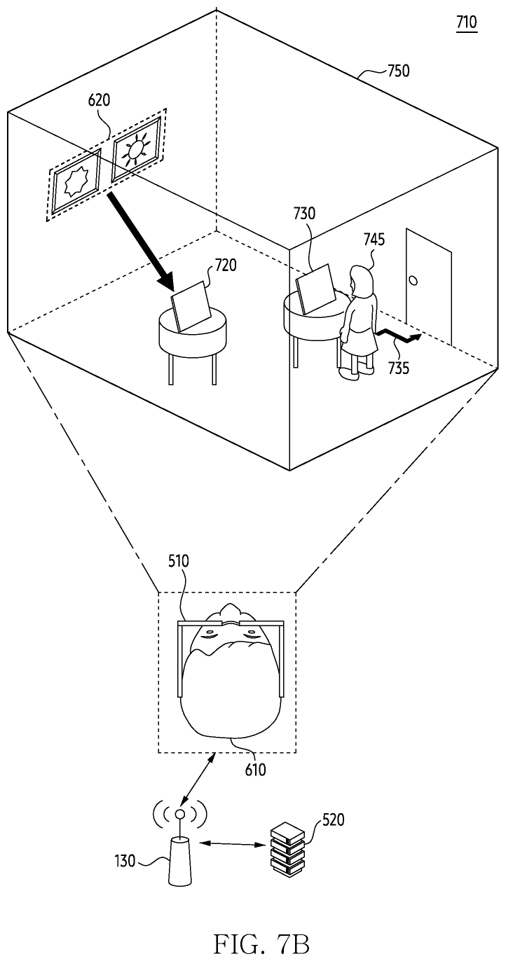

For example, the wearable device 510 may identify a plurality of multimedia contents 620 and 630 included in the virtual space from content information. The plurality of multimedia contents 620 and 630 may correspond to different properties, respectively. The wearable device 510 may obtain a priority corresponding to each of the properties using user profile information. The wearable device 510 may obtain order for outputting the plurality of multimedia contents based on the priority. An operation in which the wearable device 510 outputs (or displays) the plurality of multimedia contents in the FoV 605 of the user 610 will be described in greater detail below with reference to FIG. 7A.

Virtual space entered by the wearable device 510 according to an embodiment may be configured with one or more portions 640 and 650. One or more multimedia contents may be placed in each of the portions 640 and 650. For example, multimedia contents 620 may be placed in the portion 640. Multimedia contents 630 may be placed in the portion 650. For example, at least a portion of the portions 640 and 650 of the virtual space may be viewed through the FoV 605 of the user 610 in a state in which the user 610 is wearing the wearable device 510. For example, the wearable device 510 may display a screen representing at least a portion of the portions 640 and 650 in the FoV 605 of the user 610. The screen may include multimedia contents 620 and/or multimedia contents 630.

The portion 640 and the portion 650 may be classified by at least one visual object (e.g., a visual object representing a door or a wall). For example, the virtual space may be classified into a portion 640 of the virtual space displayed in the FoV 605 of the user 610 and a different portion 650. However, it is not limited to the embodiment described above. A position where one or more multimedia contents are placed in each of the portions 640 and 650 may be a position set by an external electronic device (e.g., the external electronic device 520 of FIG. 5). The virtual space based on the position set by the external electronic device may be referred to as an original space.

An external electronic device (e.g., the external electronic device 520 of FIG. 5) according to an embodiment may identify multimedia contents 620 and 630 included in the virtual space using content information (e.g., the content information 521 of FIG. 5) based on the execution of the content identifier 542 of FIG. 5 in a state in which the wearable device 510 has entered the virtual space. An external electronic device (e.g., the external electronic device 520 of FIG. 5) may identify the user 610 logged into the wearable device 510 that has entered the virtual space. The external electronic device may identify user preference for each of the multimedia contents 620 and 630 based on the execution of a profile identifier (e.g., the profile identifier 544 of FIG. 5) using the user profile information 523 of FIG. 5 corresponding to the user 610. An external electronic device may identify the priority of properties about the multimedia contents 620 and 630 based on the identified user preference. The identified priority and information on the multimedia contents 620 and 630 may be transmitted to the wearable device 510.

The wearable device 510 according to an embodiment may establish a communication link with an external electronic device (e.g., the external electronic device 520 of FIG. 5) in a state in which it has entered the virtual space. The wearable device 510 may receive at least one information from an external electronic device (e.g., the external electronic device 520 of FIG. 5) in a state in which a communication link is established. The wearable device 510 may obtain a visual object corresponding to each of the multimedia contents 620 and 630 based on receiving the information, based on the execution of the generator 545 of FIG. 5.

Hereinafter, an operation in which the wearable device 510 displays a visual object representing multimedia contents based on user profile information will be described in greater detail below with reference to FIGS. 7A and 7B.

FIGS. 7A to 7B show an exemplary state in which a wearable device according to an embodiment indicates obtaining a visual object corresponding to external objects included in virtual space. The wearable device 510 of FIGS. 7A and 7B may be an example of the wearable device 510 of FIGS. 5 and 6. Referring to FIG. 7A, a state 700 in which the wearable device 510 displays a visual object corresponding to multimedia contents included in the virtual space using a display is shown.

Referring to FIG. 7A, in a state 700, the wearable device 510 according to an embodiment may identify properties about the multimedia contents 620 and 630 included in the virtual space using content information (e.g., the content information 521 of FIG. 5) received from an external electronic device (e.g., the external electronic device 520 of FIG. 5) in a state in which a content identifier (e.g., the content identifier 541 of FIG. 5) is executed. For example, in case of including structured information indicating the property in the multimedia contents 620 and 630, the wearable device 510 may obtain the property using the structured information. In case of including unstructured information such as video information, image information, and/or audio information in the multimedia contents 620 and 630, the wearable device 510 may obtain one or more properties by embedding the video information, image information, and/or audio information, respectively. For example, the wearable device 510 may obtain one or more properties by synthesizing parameters indicating each of the video information, image information, and/or audio information using at least one function (e.g., concatenation function). However, it is not limited thereto.

Within a state in which a profile identifier (e.g., the profile identifier 543 of FIG. 5) is executed, the wearable device 510 according to an embodiment may obtain order for outputting the multimedia contents 620 and 630 based on one or more properties corresponding to each of the multimedia contents 620 and 630 using user profile information. For example, the wearable device 510 may obtain a priority corresponding to each of one or more properties using user profile information. The wearable device 510 may obtain order for the output based on the priority.

For example, the multimedia contents 620 may be contents based on a substantially similar first property (e.g., pop art). The wearable device 510 may select a multimedia content with the highest order for output among multimedia contents 620, based on the first property. The wearable device 510 may generate a visual object 720 representing the identified multimedia content using a generator (e.g., the generator 545 of FIG. 5). As an example, the visual object 720 may be generated based on a visual object representing the first property. The wearable device 510 may determine a position where the visual object 720 is to be placed in the FoV 605 of the user 610, based on at least one of a priority corresponding to each of one or more properties and/or order for outputting the multimedia contents. Based on the determined position, the wearable device 510 may display the visual object 720 using a display. As an example, the wearable device may use a renderer (not shown) to display the visual object 720. For example, the wearable device 510 may temporarily refrain from displaying multimedia contents 620 while displaying the visual object 720 at the position. However, it is not limited thereto.

For example, the multimedia contents 630 may be contents based on substantially similar second property (e.g., media art). The wearable device 510 may select a multimedia content with the highest order for output among multimedia contents 630, based on the second property. The wearable device 510 may generate a visual object 730 representing the identified multimedia content. As an example, the visual object 730 may refer to a preview visual object indicating a description of the multimedia contents 630. While displaying the visual object 730 in the FoV 605, the wearable device 510 may display (or place) a visual object 735 indicating a position (e.g., a position placed in the portion 650) where the multimedia contents 630 corresponding to the visual object 730 are placed, in the portion 640. As an example, the wearable device 510 may provide an audio signal indicating the position where the multimedia contents 630 are placed to the user 610 using a speaker (e.g., the speaker 570 of FIG. 5), independently of displaying the visual object 735.

For example, the position in which the visual objects 720 and 730 are placed in the FoV 605 may be determined based on the priority for each property included in profile information of a user and/or order for outputting each of the multimedia contents 620, 630. For example, the wearable device 510 may identify that the priority of the second property (e.g., media art) is relatively higher than the priority of the first property (e.g., pop art) using user profile information. The wearable device 510 may determine a position where the visual objects 720 and 730 are to be placed in the FoV 605 based on the priority for each of the properties. As an example, the position of the visual object 730 may be placed relatively closer to the user 610 than the position of the visual object 720. However, it is not limited thereto. For example, the wearable device 510 may identify the position of the other visual objects based on a position of an avatar representing the user 610 in the virtual space. An operation in which the wearable device 510 identifies the position of other visual objects based on the position of the avatar will be described in greater detail below with reference to FIG. 7B.

For example, the wearable device 510 may store information on the positions and/or multimedia contents in a memory (e.g., the memory 540 of FIG. 5). The wearable device 510 may update the stored information and/or positions based on identifying interaction with the user 610. An operation in which the wearable device 510 updates based on identifying the interaction will be described in greater detail below with reference to FIG. 8.

The wearable device 510 according to an embodiment may identify that the user 610 moves from the portion 640 of the virtual space to other portion 650. For example, the portion 650 may include a position where the multimedia contents 630 corresponding to the visual object 735 are placed. Based on identifying moving to the portion 650, the wearable device 510 may display a portion 650 that includes other visual objects different from the visual objects 720 and 730 in the FoV 605. For example, based on identifying moving to the portion 650, the wearable device 510 may request content information (e.g., the content information 521 of FIG. 5) and/or user profile information (e.g., the user profile information 523 of FIG. 5) from an external electronic device (e.g., the external electronic device 520 of FIG. 5). The wearable device 510 may determine the position of the other visual objects in the portion 650 based on the requested information.

In case that multimedia contents 620 and 630 include audio information and/or video information, the wearable device 510 according to an embodiment may obtain a playback order for playing audio and/or video corresponding to the multimedia contents 620 and 630 using content information and/or user profile information. Based on identifying an input indicating entry into virtual space, the wearable device 510 may play the audio and/or video using at least one of a display or a speaker (e.g., the speaker 570 of FIG. 5) based on the playback order. However, it is not limited thereto.

The wearable device 510 according to an embodiment may identify that a plurality of users enter into virtual space. The wearable device 510 may adjust a position where a visual object representing multimedia contents included in the virtual space is to be placed using profile information corresponding to a plurality of users. The plurality of users may use the virtual space based on the adjusted position of the visual object.

Referring to FIG. 7B, a state 710 indicating the virtual space 750 into which the wearable device 510 according to an embodiment has entered is shown. The state 710 may be configured as at least one server (e.g., the external electronic device 520 of FIG. 5) that provides virtual space, a network (e.g., a network formed by at least one intermediate node 130 including an access point (AP) and/or a base station) connecting the server and the wearable device 510, and the wearable device 510 that connects the server through a network and enables a user to use the service by inputting and outputting to virtual space service.

The external electronic device 520 according to an embodiment may receive a signal for an input indicating entry into the virtual space 750 from the wearable device 510. For example, the virtual space 750 may include the multimedia contents 620. The external electronic device 520 may identify properties about each of the multimedia contents 620 based on the execution of the content identifier 542 of FIG. 5 using the content information 521 of FIG. 5. The external electronic device 520 may identify the priority for the properties based on the execution of the profile identifier 544 of FIG. 5 using user profile information (e.g., the user profile information 523 of FIG. 5) corresponding to the user 610. The external electronic device 520 may transmit signals indicating the virtual space 750, the priority, the multimedia contents 620, and the profile information of the user to the wearable device 510. The wearable device 510 that has received the signal may display the virtual space 750 in a display area of a display by controlling the display.

The wearable device 510 according to an embodiment may generate a visual object 720 corresponding to the multimedia contents 620 or a visual object 730 corresponding to other multimedia contents (e.g., the multimedia contents 630 of FIG. 6) based on the execution of the generator 545 of FIG. 5. The wearable device 510 may place the generated visual objects 720 and 730 in the virtual space 750. The wearable device 510 may display an avatar 745 representing the user 610 in the virtual space 750 based on at least one signal received from the external electronic device 520. The wearable device 510 may place the position of the visual objects 720 and 730 in the virtual space 750 based on the position of the avatar 745, using the priority for each property of the multimedia contents 620. As an example, in case that the priority for multimedia contents corresponding to the visual object 730 is higher than the priority for the multimedia contents 620 corresponding to the visual object 720, the position of the visual object 730 may be placed relatively closer to the position where the avatar 745 is placed than the position of the visual object 720. However, it is not limited to the embodiment described above.

As described above, the wearable device 510 may obtain order for outputting multimedia contents included in the virtual space based on the user's preference. Based on the order, the wearable device 510 may adjust the number of outputs of multimedia contents in the virtual space. The wearable device 510 may reduce the amount of data to be processed to provide virtual space service to a user by adjusting the number.

FIG. 8 shows an exemplary state indicating an interaction between a wearable device and a user according to an embodiment. The wearable device 510 of FIG. 8 may be an example of the wearable device 510 of FIGS. 5 to 7B. Referring to FIG. 8, a state 800 in which the wearable device 510 displays visual objects corresponding to the multimedia contents 620 in the FoV using a display based on identifying an interaction with the user 610 will be shown.

In the state 800 according to an embodiment, the wearable device 510 according to an embodiment may identify an interaction between the user 610 and the visual object 720 using an interaction identifier (e.g., the interaction identifier 547 of FIG. 5). For example, the wearable device 510 may update the visual object 720 based on identifying the interaction. The wearable device 510 according to an embodiment may update visual objects to be displayed in the virtual space based on identifying an interaction between a user and the visual object 720 (or the multimedia contents 620). To perform the update, the wearable device 510 may use information (e.g., property, position information) on the multimedia contents 620 stored in a memory and/or position where the visual object 720 is placed in a portion (e.g., the portion 640 of FIGS. 6 and 7A) of the virtual space.

For example, the wearable device 510 may receive a sound signal indicating that at least one of the multimedia contents 620 is selected from the user 610 using a microphone (e.g., the microphone 560 of FIG. 5). The sound signal may include voice information of the user 610. The sound signal may include a speech act of the user 610. The sound signal may refer, for example, to an input for the user 610 to control the visual object 720 displayed in the FoV 605. For example, the sound information may include information on the multimedia contents 620 and/or the visual object 720. The wearable device 510 may identify information on multimedia contents included in the sound signal and/or user intention based on receiving the sound signal.

For example, the wearable device 510 may identify natural language 850 included in the sound signal. As an example, although not shown, the wearable device 510 may include hardware and/or software for processing the identified natural language 850. The natural language 850 may be configured with one or more sentences (e.g., “Open the pop art work and show in detail”).

For example, the wearable device 510 may identify words (e.g., “pop art work”) indicating at least one of multimedia contents included in the virtual space included in the one or more sentences of the natural language 850. As an example, words indicating at least one of multimedia contents may indicate a name (e.g., work A) for referring to each of the multimedia contents, and/or a property (e.g., painting, pop art, media art, or impressionism) for classifying the multimedia contents. However, it is not limited thereto. As an example, the words may indicate positions where multimedia contents are placed.

For example, the wearable device 510 may identify multimedia contents (e.g., the multimedia contents 620 of FIG. 8) corresponding to the words and/or the visual object 720 corresponding to the multimedia contents based on identifying the words indicating the at least one.

For example, the wearable device 510 may infer user intention included in the natural language 850. For example, the wearable device 510 may identify one or more sentences (e.g., “open it and show it in detail”) in the natural language 850. The wearable device 510 may change the position of multimedia contents (e.g., the multimedia contents 620) indicated by the user 610 in the natural language 850 or may set a priority corresponding to the multimedia contents to be high, based on identifying the one or more sentences.

For example, the wearable device 510 may identify the multimedia contents 620 based on the first property (e.g., pop art) based on identifying the natural language 850. The wearable device 510 may generate visual objects 821 and 822 representing each of the multimedia contents 620, based on identifying at least one sentence (e.g., “open it and show it in detail”) among the natural language 850. The wearable device 510 may display the visual objects 821 and 822 in the FoV 605 using a display by replacing the visual object 720 based on generating the visual objects 821 and 822. As an example, while displaying the visual object 720, the wearable device 510 may display the visual objects 821 and 822 at each of positions that are different from the position at which the visual object 720 is displayed in the FoV 605. The wearable device 510 may store multimedia contents corresponding to each of the visual objects 821 and 822 and a position where the visual objects 821 and 822 are placed in a memory.

The wearable device 510 according to an embodiment may determine a position where the visual objects 821 and 822 are to be placed based on order for outputting multimedia contents. For example, the wearable device 510 may determine the position of the visual object 822 to be relatively closer to the user 610 than the position of the visual object 821 using user profile information (e.g., the user profile information 521 of FIG. 5). However, it is not limited thereto.

The wearable device 510 according to an embodiment may identify other natural language including information different from the natural language 850. For example, other natural language may include one or more words (e.g., “I won't see that anymore”). The wearable device may temporarily refrain from displaying the multimedia contents 620 included in the FoV 605 and/or the visual object 720 corresponding to the multimedia contents based on identifying the other natural language. However, it is not limited to the embodiment described above.

The wearable device 510 according to an embodiment may identify an input indicating change to the virtual space included in the state 600 of FIG. 6 based on identifying a sound signal using a microphone. The state 600 of FIG. 6 may refer, for example, to the original space of the virtual space described above in FIG. 6. The original space may refer, for example, to virtual space set by an external electronic device (e.g., the external electronic device 520 of FIG. 5). The wearable device 510 may provide the original space to the user 610 by replacing a space (e.g., virtual space included in the state 800 of FIG. 8) where the position of multimedia contents is placed based on profile information (e.g., the user profile information 523 of FIG. 5) of the user 610. However, it is not limited to the embodiment described above.

According to an embodiment, an external electronic device (e.g., the external electronic device 520 of FIG. 5) may establish a communication link using the wearable device 510 that has entered the virtual space and a communication circuit. For example, the external electronic device may transmit information on the multimedia contents 620 included in the virtual space to the wearable device 510 based on the execution of the content identifier 542 and/or the profile identifier 544 of FIG. 5. The wearable device 510 may obtain a visual object 720 corresponding to the information based on the execution of the generator 545 of FIG. 5 based on receiving the information. For example, the wearable device 510 may identify the natural language 850 based on the execution of the interaction identifier 547 of FIG. 5. The wearable device 510 may generate the visual objects 821 and 822 corresponding to the multimedia contents based on the execution of the generator 545 of FIG. 5 using the identified natural language 850.

As described above, the wearable device 510 according to an embodiment may change the position where multimedia contents which are placed in the virtual space are to be displayed based on identifying an interaction with the user 610. The wearable device 510 may provide virtual space suitable for the user 610 by changing the position. The wearable device 510 may provide a more realistic augmented reality service to the user by providing a suitable virtual space for the user 610.

FIG. 9 is an exemplary flowchart indicating an operation of a wearable device according to an embodiment. At least one of operations of FIG. 9 may be performed by the wearable device 510 of FIG. 5 and/or the processor 530 of FIG. 5. In the following embodiment, each operation may be performed sequentially, but is not necessarily performed sequentially. For example, order of each operation may be changed, or at least two operations may be performed in parallel.

Referring to FIG. 9, in operation 910, a wearable device according to an embodiment may identify a plurality of multimedia contents included in virtual space based on identifying an input indicating entry into the virtual space. For example, the wearable device may enter the virtual space in response to initiating the execution of at least one application stored in a memory. In response to identifying the entry into the virtual space, the wearable device may establish a communication link with the external electronic device 520 of FIG. 5 for providing virtual space service using the communication circuit 525 of FIG. 5. The wearable device may receive the content information 521 of FIG. 5 including information on multimedia contents included in the virtual space through the communication link. The wearable device may identify property (or information) of multimedia contents included in the virtual space based on the received content information.

Referring to FIG. 9, in operation 920, the wearable device according to an embodiment may obtain an order for outputting a plurality of multimedia contents based on profile information of a user corresponding to the wearable device. The wearable device may obtain user profile information (e.g., the user profile information 523 of FIG. 5) using a communication link established with an external electronic device. The wearable device may obtain a priority for each of the properties about multimedia contents according to user preference included in the user profile information using the user profile information. The wearable device may obtain order for outputting multimedia contents based on the priority.

Referring to FIG. 9, in operation 930, the wearable device according to an embodiment may display at least a portion of the virtual space including a visual object representing at least one multimedia content among a plurality of multimedia contents in the user's FoV through a display, based on order. The plurality of multimedia contents may be classified based on at least one property. The wearable device may identify at least one multimedia content among a plurality of multimedia contents based on order. The identified at least one multimedia content may correspond to a first order among orders according to the user preference. The at least one multimedia content may be an example of designated content representing a property for classifying the plurality of multimedia contents. The wearable device may set designated content representing the property. However, it is not limited to the embodiment described above. For example, the visual object may be referred to the visual objects 720 and 730 of FIG. 7A. The wearable device may use the generator 545 of FIG. 5 to generate the visual object.

For example, the wearable device may arrange a visual object in a portion (e.g., the portion 640 of FIG. 6) including the user (or user's avatar) of the wearable device among a plurality of portions (e.g., the portions 640 and 650 of FIG. 6) of the virtual space. The wearable device may display the placed visual object in the user's FoV (e.g., the FoV 605 of FIG. 6) using a display (e.g., the display 550 of FIG. 5). However, it is not limited to the embodiment described above. As an example, the wearable device may output each of the audio signals corresponding to multimedia contents through a speaker, based on order, independently of displaying a visual object through a display.

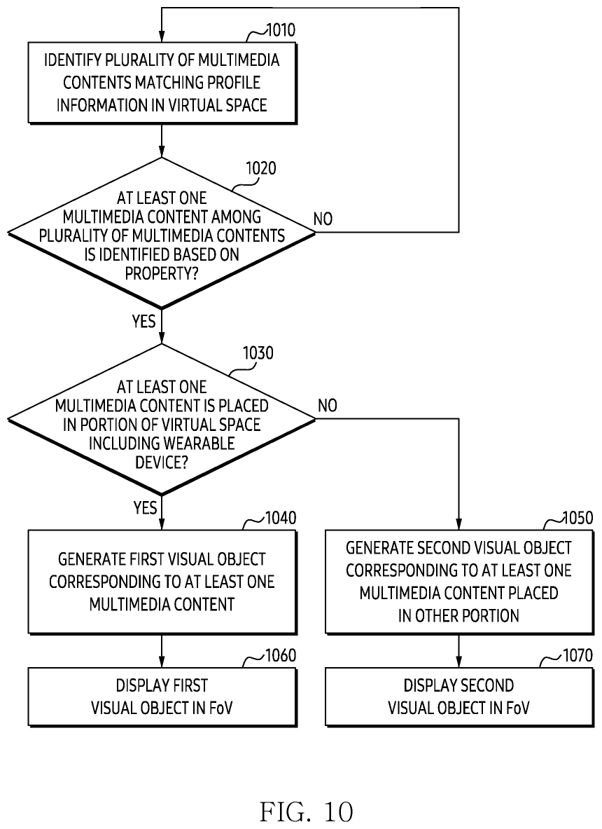

FIG. 10 is an exemplary flowchart indicating an operation of a wearable device according to an embodiment. At least one of operations of FIG. 10 may be performed by the wearable device 510 of FIG. 5 and/or the processor 530 of FIG. 5. In the following embodiment, each operation may be performed sequentially, but is not necessarily performed sequentially. For example, order of each operation may be changed, or at least two operations may be performed in parallel.

Referring to FIG. 10, in operation 1010, a wearable device according to an embodiment may identify a plurality of multimedia contents matching profile information in virtual space. Operation 1010 may be related to at least one of operation 910 and/or operation 920 of FIG. 9. The wearable device may receive content information (e.g., the content information 521 of FIG. 5) including a plurality of multimedia contents included in the virtual space from an external electronic device (e.g., the external electronic device 520 of FIG. 5). The wearable device may receive user profile information (e.g., the user profile information 523 of FIG. 5) indicating user preference including order for each of the plurality of multimedia contents from the external electronic device. The wearable device may identify properties about each of the plurality of multimedia contents using the user profile information.

Referring to FIG. 10, in operation 1020, the wearable device according to an embodiment may identify whether at least one multimedia content among a plurality of multimedia contents has been identified based on a property. A plurality of multimedia contents may be classified based on at least one property. The wearable device may select or identify at least one multimedia content among a plurality of classified multimedia contents based on at least one property. For example, referring to FIG. 10, in case that at least one multimedia content among a plurality of multimedia contents is not identified based on a property (operation 1020—No), the wearable device according to an embodiment may perform operation 1010.

Referring to FIG. 10, in case that at least one multimedia content among a plurality of multimedia contents is identified based on a property (operation 1020—Yes), in operation 1030, the wearable device according to an embodiment may identify whether at least one multimedia content is placed in a portion of virtual space including the wearable device. The virtual space may be classified into a plurality of portions (e.g., the portions 640 and 650 of FIG. 6). The wearable device may display at least a portion of the plurality of portions using a display in FoV (e.g., the FoV 605 of FIG. 6). For example, the wearable device may obtain information on multimedia contents placed in each of the plurality of portions based on content information received from an external electronic device. It is possible to identify whether at least one multimedia content is placed in a portion (e.g., the portion 650 of FIG. 6) where a user (or user's avatar) wearing the wearable device is located, using the information on multimedia contents placed in each of the plurality of obtained portions.

Referring to FIG. 10, in case that at least one multimedia content is placed in a portion of virtual space including a wearable device (operation 1030—Yes), in operation 1040, the wearable device according to an embodiment may generate a first visual object corresponding to at least one multimedia content. The at least one multimedia content may be at least one among the multimedia contents 620 of FIG. 6. The wearable device may generate the first visual object using the generator 545 of FIG. 5. For example, the wearable device may generate the first visual object based on a type of virtual space. The wearable device may generate the first visual object from an external electronic device based on defined modeling information for generating the first visual object. The first visual object may be referred to the visual object 720 of FIG. 7A. The first visual object may be an example of a visual object representing the at least one multimedia content.

Referring to FIG. 10, in operation 1060, the wearable device according to an embodiment may display the first visual object in FoV. The wearable device may obtain order corresponding to at least one multimedia content using user profile information. The wearable device may set a position where the first visual object is to be placed in the virtual space based on the order. As an example, the higher the order, the position where the first visual object is to be placed is to be placed close to a user (or a user's avatar).

Referring to FIG. 10, in case that at least one multimedia content is not placed in a portion of virtual space including a wearable device (operation 1030—No), in operation 1050, the wearable device according to an embodiment may generate a second visual object corresponding to at least one multimedia content placed in other portion of the virtual space. The at least one multimedia content placed in other portion of the virtual space may be referred to the multimedia contents 630 of FIG. 6. The other portion may be included in the portion 650 of FIG. 6. The second visual object may be referred to the visual object 730 of FIG. 7A. The wearable device may display a visual object (e.g., the visual object 735 of FIG. 7A) indicating the position of the at least one multimedia content while placing the second visual object in a portion (e.g., the portion 640 of FIG. 6) or displaying in the FoV.

Referring to FIG. 10, in operation 1070, the wearable device according to an embodiment may display the second visual object in the FoV. An operation performed by the wearable device in operation 1070 may be related to at least a portion of the operations performed in operation 1060. A state in which the wearable device displays the first visual object and/or the second visual object may be referred to the state 700 of FIG. 7A.

For example, the wearable device may identify an interaction between a user and the visual objects using a microphone in a state of displaying the first visual object and/or the second visual object. The wearable device may update the position of the first visual object and/or the second visual object placed in the virtual space based on identifying the interaction. However, it is not limited to the embodiment described above.

FIG. 11 shows an exemplary state in which a wearable device according to an embodiment indicates obtaining a visual object based on a type of virtual space. The wearable device 510 of FIG. 11 may be an example of the wearable device 510 of FIGS. 5 to 9. Referring to FIG. 11, a state 1100 in which the wearable device 510 displays a visual object based on a type of virtual space is shown.

The wearable device 510 according to an embodiment may obtain visual objects 1120, 1121, and 1130 representing multimedia contents 620 and 630 based on a type of virtual space. For example, the wearable device 510 may receive information indicating the type of virtual space from an external electronic device (e.g., the external electronic device 520 of FIG. 5) in response to an input indicating entry into the virtual space. The type of virtual space may refer, for example, to a theme of virtual space, a style of virtual space, and/or a form of virtual space. As an example, the type of virtual space may include information on a space displaying multimedia contents, such as an exhibition, a museum, and an art gallery.

For example, the wearable device 510 may obtain defined modeling information of a visual object that is generable in the virtual space based on receiving information indicating the type of the virtual space received from an external electronic device. The wearable device 510 may generate the visual objects 1120, 1121, and 1130 based on the generator 545 of FIG. 5 using the defined modeling information.

For example, the wearable device 510 may identify multimedia contents 620 and 630 included in the virtual space. The wearable device 510 may obtain order for outputting the multimedia contents 620 and 630 using user profile information (e.g., the user profile information 523 of FIG. 5). The wearable device 510 may obtain a visual object representing the multimedia contents 620 and 630 using a generator based on the order.

For example, the wearable device 510 may use information indicating the type of virtual space to generate the visual object 1121 representing the multimedia content 620. The wearable device 510 may generate the visual object 1121 by combining the visual object 1120 based on the type of virtual space. The wearable device 510 may determine a position where the visual objects 1120 and 1121 are to be placed based on profile information of the user. The wearable device 510 may display the visual objects 1120 and 1121 at the determined position in the FoV 605 of the user 610 by controlling a display. As an example, the visual object 1120 may include a visual object indicating a fake wall and lighting based on the type of virtual space.

For example, the wearable device 510 may use information indicating the type of virtual space to generate the visual object 1130 representing multimedia contents 630. The wearable device 510 may generate the visual object 1130 of types such as display panel, pamphlet, or poster based on the type of virtual space. The wearable device 510 may provide a position and/or information of the multimedia contents 630 to the user 610 using text and image information included in the visual object 1130. However, it is not limited to the embodiment described above.

The wearable device 510 according to an embodiment may change the visual objects 1120, 1121, and 1130 based on identifying an interaction with the user 610 using a microphone (e.g., the microphone 560 of FIG. 5). For example, the state of displaying the changed visual objects may be referred to the state 600 of FIG. 6, the state 700 of FIG. 7A, the state 710 of FIG. 7B, and/or the state 800 of FIG. 8.

As described above, the wearable device 510 according to an embodiment may identify the type of virtual space to generate the visual objects 1120, 1121, and 1130 representing the multimedia contents 620 and 630. The wearable device 510 may obtain an atmosphere suitable for virtual space by generating the visual objects 1120, 1121, and 1130 based on the type of virtual space. The wearable device 510 may provide a more realistic augmented reality service to the user 610 by obtaining the atmosphere.

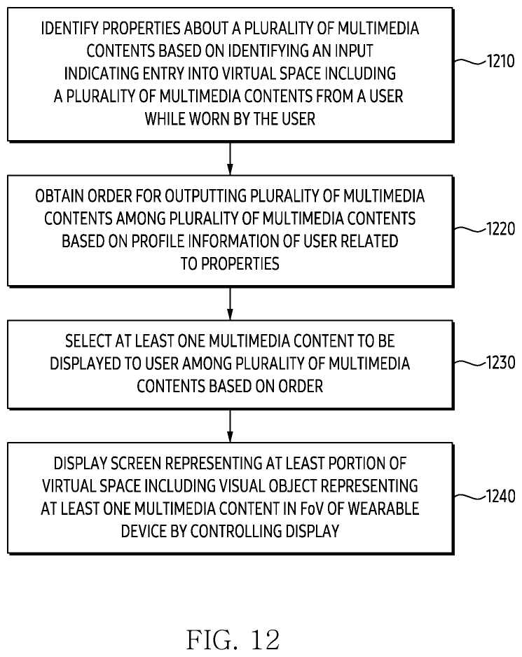

FIG. 12 is an exemplary flowchart indicating an operation of a wearable device according to an embodiment. At least one of the operations of FIG. 12 may be performed by the wearable device 510 of FIG. 5 and/or the processor 530 of FIG. 5. In the following embodiment, each operation may be performed sequentially, but is not necessarily performed sequentially. For example, order of each operation may be changed, or at least two operations may be performed in parallel.

Referring to FIG. 12, in operation 1210, the wearable device according to an embodiment may identify properties about a plurality of multimedia contents based on identifying an input indicating entry into virtual space including a plurality of multimedia contents from a user while worn by the user. The wearable device may receive content information, user profile information, and/or information indicating the type of virtual space from the external electronic device 520 of FIG. 5 based on identifying the input. The wearable device may identify the property about multimedia contents included in the virtual space in a state in which the content identifier 541 of FIG. 5 is executed using content information.

Referring to FIG. 12, in operation 1220, the wearable device according to an embodiment may obtain an order for outputting a plurality of multimedia contents among the plurality of multimedia contents based on profile information of a user related to properties. The wearable device may obtain a priority for each property about multimedia contents mapped to a user preference included in a user profile information using the profile identifier 543 of FIG. 5. The wearable device may obtain order for outputting multimedia contents using the priority.

Referring to FIG. 12, in operation 1230, the wearable device according to an embodiment may select at least one multimedia content to be displayed to the user from among a plurality of multimedia contents based on order. The wearable device may identify the at least one multimedia content mapped to first order. The wearable device may select the at least one multimedia content based on a property corresponding to each of a plurality of multimedia contents. For example, a plurality of multimedia contents may include information on substantially similar properties.

Referring to FIG. 12, in operation 1240, the wearable device according to an embodiment may display a screen representing at least a portion of virtual space including a visual object representing at least one multimedia content in the FoV of the wearable device by controlling a display. For example, the virtual space may include one or more portions (e.g., the portions 640 and 650 of FIG. 6). Each of the portions may include different multimedia contents. The wearable device may generate a visual object using the generator 545 of FIG. 5. For example, the wearable device may generate a visual object (e.g., the visual objects 1120, 1121, 1130 of FIG. 11) based on the type of virtual space. The wearable device may identify the position of the generated visual object based on a user preference for the at least one multimedia content corresponding to the visual object. The wearable device may generate at least one screen representing the portion including a visual object using a renderer (not shown). The wearable device may display the at least one screen in the user's FoV (e.g., the FoV 605 of FIG. 6) using a display (e.g., the display 550 of FIG. 5). A state in which the wearable device displays the at least one screen may be referred to the state 1100 of FIG. 11.

The wearable device may obtain order for outputting multimedia contents using profile information of a user wearing the wearable device included in the virtual space. The wearable device may display a screen including a visual object representing at least one multimedia content among multimedia contents on a display based on order. The wearable device may provide a virtual space service suitable for a user by displaying the screen.

The wearable device according to an embodiment may provide virtual space suitable for a user using profile information of a user wearing the wearable device and information on multimedia contents included in the virtual space. A method for matching information on multimedia contents and profile information by the wearable device is required.

As described above, a wearable device according to an embodiment may comprise: a display and a processor. The processor may be configured to identify a plurality of multimedia contents included in virtual space, based on identifying an input indicating entry into the virtual space. The processor may be configured to obtain an order for outputting the plurality of multimedia contents, based on profile information of a user corresponding to the wearable device. The processor may be configured to display at least a portion of the virtual space including a visual object representing at least one multimedia content among the plurality of multimedia contents through the display, in the user's field-of-view (FoV), based on the order.

For example, the processor may be configured to identify properties about the plurality of multimedia contents based on embedding video information and audio information included in each of the plurality of multimedia contents. The processor may be configured to obtain the order based on the profile information related to the properties.

For example, the processor may be configured to obtain the order for outputting the plurality of multimedia contents, using the profile information of the user indicating a priority for each of the properties.

For example, the processor may be configured to select the at least one multimedia content among the plurality of multimedia contents, based on the obtained order. The processor may be configured to obtain the visual object representing the selected at least one multimedia content.

For example, the profile information may include at least one of identification information of the user or information indicating browsing of each of the plurality of multimedia contents.

For example, the processor may be configured to place the visual object in the FoV, based on the order.

For example, the processor may be configured to display another portion including another visual object different from the visual object, in the FoV, based on identifying that the user moves from at least a portion of the virtual space to other portion.

For example, the processor may be configured to update the visual object, based on identifying an interaction between the user and the visual object.

For example, the wearable device may include a microphone. The processor may be configured to receive a sound signal indicating selection of the at least one multimedia content corresponding to the visual object, from the user, using the microphone. The processor may be configured to identify the interaction based on receiving the sound signal.

For example, the processor may be configured to identify a type of the virtual space. The processor may be configured to obtain the visual object based on the type.

As described above, a method of the wearable device according to an embodiment may comprise identifying properties about the plurality of multimedia contents based on identifying an input indicating entry into virtual space including the plurality of multimedia contents, from the user, while the wearable device is worn by the user. The method may comprise obtaining an order for outputting the plurality of multimedia contents among the plurality of multimedia contents, based on profile information of the user related to the properties. The method may comprise selecting at least one multimedia content to be displayed to the user, among the plurality of multimedia contents, based on the order. The method may comprise displaying a screen representing at least a portion of the virtual space including a visual object representing the at least one multimedia content in a FoV of the wearable device, by controlling a display.

For example, the method may comprise identifying the properties about the plurality of multimedia contents based on embedding video information and audio information included in each of the plurality of multimedia contents.

For example, the method may comprise obtaining the order by using the profile information of the user indicating a priority for each of the properties.

For example, the method may comprise obtaining the order, based on the profile information including at least one information of identification information of the user or information indicating browsing of each of the plurality of multimedia contents.

For example, the method may comprise placing the visual object in the FoV, based on the order.

For example, based on identifying that the user moves from at least a portion of the virtual space to other portion, in the FoV, the method may comprise displaying another screen that includes another visual object different from the visual object and represents the other portion.

For example, the method may comprise updating the visual object, based on identifying an interaction between the user and the visual object.

For example, the wearable device may include a microphone. The method may comprise receiving a sound signal indicating selection of the at least one multimedia content corresponding to the visual object, from the user, by using the microphone. The method may comprise identifying the interaction, based on receiving the sound signal.

For example, the method may comprise selecting the at least one multimedia content among the plurality of multimedia contents, according to the obtained order.

As described above, a wearable device according to an embodiment may comprise: a display and a processor. The processor may be configured to identify properties about the plurality of multimedia contents based on identifying an input indicating entry into virtual space including the plurality of multimedia contents, from the user, while the wearable device is worn by the user. The processor may be configured to obtain an order for outputting the plurality of multimedia contents, based on profile information of the user related to the properties. The processor may be configured to select at least one multimedia content to be displayed to the user, among the plurality of multimedia contents, based on the order. The processor may be configured to display a screen representing at least a portion of the virtual space including a visual object representing the at least one multimedia content in the FoV of the wearable device by controlling the display.

For example, the processor may be configured to identify the properties about the plurality of multimedia contents based on embedding video information and audio information included in each of the plurality of multimedia contents.

For example, the processor may be configured to obtain the order for outputting the plurality of multimedia contents by using the profile information of the user indicating a priority for each of the properties.

For example, the profile information may include at least one information of identification information of the user or information indicating browsing of each of the plurality of multimedia contents.

For example, the processor may be configured to place the visual object in the FoV, based on the order.

For example, based on identifying that the user moves from at least a portion of the virtual space to the other portion 650, the processor may be configured to display another screen representing the other portion and include another visual object different from the visual object, in the FoV.

As described above, a method of the wearable device according to an embodiment may comprise identifying the plurality of multimedia contents included in a virtual space, based on identifying an input indicating entry into the virtual space. The method may comprise obtaining an order for outputting the plurality of multimedia contents, based on profile information of a user corresponding to the wearable device. The method may comprise displaying at least a portion of the virtual space including a visual object representing at least one multimedia content among the plurality of multimedia contents through the display, in the user's FoV, based on the order.

For example, the method may comprise identifying the properties about the plurality of multimedia contents based on embedding video information and audio information included in each of the plurality of multimedia contents. The method may comprise obtaining the order based on the profile information related to the properties.

For example, the method may comprise obtaining the order for outputting the plurality of multimedia contents, using the profile information of the user indicating a priority for each of the properties.

For example, the method may comprise selecting the at least one multimedia content among the plurality of multimedia contents, based on the obtained order. The method may comprise obtaining the visual object representing the selected at least one multimedia content.

For example, the method may comprise placing the visual object in the FoV, based on the order.

The apparatus described above may be implemented as a combination of hardware components, software components, and/or hardware components and software components. For example, the devices and components described in the embodiments may be implemented using one or more general purpose computers or special purpose computers such as processors, controllers, arithmetical logic unit (ALU), digital signal processor, microcomputers, field programmable gate array (FPGA), PLU (programmable logic unit), microprocessor, any other device capable of executing and responding to instructions. The processing device may perform an operating system OS and one or more software applications performed on the operating system. In addition, the processing device may access, store, manipulate, process, and generate data in response to execution of the software. For convenience of understanding, although one processing device may be described as being used, a person skilled in the art may see that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, code, instruction, or a combination of one or more of them and configure the processing device to operate as desired or command the processing device independently or in combination. Software and/or data may be embodied in any type of machine, component, physical device, computer storage medium, or device to be interpreted by a processing device or to provide instructions or data to the processing device. The software may be distributed on a networked computer system and stored or executed in a distributed manner. Software and data may be stored in one or more computer-readable recording media.

The method according to the embodiment may be implemented in the form of program instructions that may be performed through various computer means and recorded in a computer-readable medium. In this case, the medium may continuously store a computer-executable program or temporarily store the program for execution or download. In addition, the medium may be a variety of recording means or storage means in which a single or several hardware are combined and is not limited to media directly connected to any computer system and may be distributed on the network. Examples of media may include magnetic media such as hard disks, floppy disks and magnetic tapes, optical recording media such as CD-ROMs and DVDs, magneto-optical media such as floppy disks, ROMs, RAMs, flash memories, and the like to store program instructions. Examples of other media include app stores that distribute applications, sites that supply or distribute various software, and recording media or storage media managed by servers.

Although embodiments have been described according to limited embodiments and drawings as above, various modifications and modifications are possible from the above description to those of ordinary skill in the art. For example, even if the described techniques are performed in a different order from the described method, and/or components such as the described system, structure, device, circuit, etc. are combined or combined in a different form from the described method or are substituted or substituted by other components or equivalents, appropriate results may be achieved.

Therefore, other implementations, other embodiments, and equivalents to the claims fall within the scope of the claims to be described later.

In other words, while the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A wearable device, comprising:
a display; and
a processor;
wherein the processor is configured to:
identify a plurality of multimedia contents included in a virtual space, based on identifying an input indicating entry into the virtual space;
obtain an order for outputting the plurality of multimedia contents, based on profile information of a user corresponding to the wearable device, and
display at least a portion of the virtual space including a visual object representing at least one of the plurality of multimedia contents through the display, in the user's field-of-view, FoV, based on the order.

2. The wearable device of claim 1,
wherein the processor is configured to:
identify properties about the plurality of multimedia contents based on embedding video information and audio information included in each of the plurality of multimedia contents, and
obtain the order based on the profile information related to the properties.

3. The wearable device of any claim 1,
wherein the processor is further configured to:
obtain the order for outputting the plurality of multimedia contents, using the profile information of the user indicating a priority for each of the properties.

4. The wearable device of claim 1,
wherein the processor is configured to:
select the at least one multimedia content among the plurality of multimedia content, based on the obtained order; and
obtain the visual object representing the selected the at least one multimedia content.

5. The wearable device of claim 1,
wherein the profile information includes at least one of identification information of the user or information indicating browsing of each of the plurality of multimedia contents.

6. The wearable device of claim 1,
wherein the processor is further configured to:
place the visual object in the FoV, based on the order.

7. The wearable device of claim 1,
wherein the processor is further configured to:
based on identifying that the user moves from at least a portion of the virtual space to another portion, display another portion including another visual object different from the visual object, in the FoV.

8. The wearable device of claim 1,
wherein the processor is further configured to:
update the visual object, based on identifying an interaction between the user and the visual object.

9. The wearable device of claim 1,
wherein the wearable device includes a microphone,
wherein the processor is further configured to:
receive a sound signal indicating selection of the at least one multimedia content corresponding to the visual object, from the user, using the microphone, and
identify the interaction based on receiving the sound signal.

10. The wearable device of claim 1,
wherein the processor is further configured to:
identify a type of the virtual space, and
obtain the visual object based on the type.

11. A method of a wearable device comprising:
identifying properties about a plurality of multimedia contents based on identifying an input indicating entry into a virtual space including the plurality of multimedia contents, from a user, while the wearable device is worn by the user,
obtaining an order for outputting the plurality of multimedia contents, based on profile information of the user related to the properties,
selecting at least one multimedia content to be displayed to the user, among the plurality of multimedia contents, based on the order, and
displaying a screen representing at least a portion of the virtual space including a visual object representing the at least one multimedia content in a field-of-view, FoV of the wearable device, by controlling a display.

12. The method of the wearable device of claim 11, further comprising:
identifying the properties about the plurality of multimedia contents based on embedding video information and audio information included in each of the plurality of multimedia contents.

13. The method of the wearable device of claim 11, further comprising:
obtaining the order using the profile information of the user indicating a priority for each of the properties.

14. The method of the wearable device of claim 11, further comprising:
obtaining the order, based on the profile information including at least one of identification information of the user or information indicating browsing of each of the plurality of multimedia contents.

15. The method of the wearable device of claim 11, further comprising:
placing the visual object in the FoV, based on the order.

16. The method of the wearable device of claim 11, further comprising:
based on identifying that the user moves from at least a portion of the virtual space to another portion, displaying another screen including another visual object different from the visual object and representing the another portion, in the FoV.

17. The method of the wearable device of claim 11, further comprising:
updating the visual object, based on identifying an interaction between the user and the visual object.

18. The method of the wearable device of claim 11, wherein the wearable device includes a microphone,
wherein the method further comprising:
receiving a sound signal indicating selection of the at least one multimedia content corresponding to the visual object, from the user, using the microphone, and
identifying the interaction, based on receiving the sound signal.

19. The method of the wearable device of claim 11, further comprising:
selecting the at least one multimedia content among the plurality of multimedia contents, according to the obtained order.

20. A wearable device, comprising:
a display; and
a processor;
wherein the processor is configured to:
identify properties about a plurality of multimedia contents based on identifying an input indicating entry into a virtual space including the plurality of multimedia contents, from a user, while the wearable device is worn by the user,
obtain an order for outputting the plurality of multimedia contents, based on profile information of the user related to the properties,
select at least one multimedia content to be displayed to the user, among the plurality of multimedia contents, based on the order, and
display a screen representing at least a portion of the virtual space including a visual object representing the at least one multimedia content in a field-of-view, FoV of the wearable device by controlling the display.
